(19) United States
(12) Patent Application Publication
(10) Pub. No.: US 2020/0221214 A1
(43) Pub. Date: Jul. 9, 2020

(54) LOW PROFILE DUAL DRIVER MAGNET

(71) Applicant: Oren MORDECHAI, Ramat Hasharon (IL)

(72) Inventor: Oren MORDECHAI, Ramat Hasharon (IL)

(21) Appl. No.: 16/647,514

(22) PCT Filed: Sep. 6, 2018
(86) PCT No.: PCT/IL2018/051009

§ 371 Date: Mar. 15, 2020

Related U.S. Application Data
(60) Provisional application No. 62/559,567, filed on Sep. 17, 2017.

(51) Int. Cl. H04R 1/24; H04R 7/18; H04R 7/12; H04R 9/06; H04R 9/02; H04R 9/04

(52) U.S. Cl. CPC H04R 1/24; H04R 7/18; H04R 7/12; H04R 2400/11; H04R 9/025; H04R 9/043; H04R 9/06

(57) ABSTRACT

The disclosed technology relates to speaker drivers and micro-drivers, and more particularly to speaker drivers that include a woofer and a tweeter driven by a first and a second magnetic circuit, respectively, both magnetic circuits sharing a single magnet.

### FIELD OF THE INVENTION

The disclosed technology relates to speaker drivers and micro-drivers, and more particularly to loudspeaker or headphone drivers that include a woofer and a tweeter driven by a first and a second magnetic circuit, respectively, both magnetic circuits sharing a single magnet.

### BACKGROUND OF THE INVENTION

Speaker drivers and micro-drivers are electro-acoustic converters, which accept electric signals and transduce them into soundwaves. A conventional speaker driver has a magnetic circuit provided in a frame or chassis, covered by a diaphragm. The magnetic circuit usually includes a permanent magnet and magnetically permeable components, such as a yoke and top or bottom plates, so that the magnetic field is directed from the north pole of the magnet, through the magnetic permeable components, back to the south pole of the magnet. A voice coil is movably disposed within a gap in the magnetic circuit, wherein the edge of the voice coil is attached to the diaphragm. As electric current is fed to the voice coil, according to Fleming's left-hand rule, another magnetic field is created, vibrating the voice coil either in the same direction or opposed to the magnetic field generated by the magnetic circuit. Accompanying this, the diaphragm connected to the voice coil is driven to reproduce sound.

A single driver with one diaphragm is not suitable for providing full performance over the whole audible frequency range. Generally, a speaker, which includes more than one driver, or a system of more than one speaker, each including a single driver, should be provided in order to cover both high- and low-range frequencies. Coaxial speakers, including both a woofer covering low-frequency range, and a tweeter covering high-frequency range, are known in the art. However, known coaxial speakers utilize separate magnetic circuits with more than one magnet, each magnet separately dedicated to a different magnetic circuit.

There is an unmet need for a unified driver, including both a woofer and a tweeter, utilizing a smaller amount of components in order to reduce the required space and thus the size of the speaker, without compromising sound quality.

### SUMMARY OF THE INVENTION

Aspects of the disclosed technology, according to some embodiments thereof, relate to speaker drivers. More specifically, aspects of the disclosed technology, according to some embodiments thereof, relate to speaker drivers that include a woofer and a tweeter driven by a first and a second magnetic circuit, respectively, both magnetic circuits sharing a single magnet.

Moreover, both the first and the second magnetic circuits share additional magnetically permeable components, such as a single top plate, a yoke and an optional cup. In order to focus the magnetic flux passing through each magnetic circuit, the top plate includes a geometrical separating feature, which separates between a first plate portion and a second plate portion. The first magnetic circuit includes a first gap and the second magnetic circuit includes a second gap, both first and second gaps are parallel, radially surrounding the outer and inner edges of the magnet, respectively. A woofer voice coil, having a woofer voice coil wire, is disposed within the first gap, and a tweeter voice coil, having a tweeter voice coil wire, is disposed within the second gap. The middle point along the vertical length of the woofer voice coil wire and the middle point along the vertical length of the tweeter voice coil wire are horizontally aligned, thus offering improved time alignment between the woofer and the tweeter.

Advantageously, driving both a woofer and a tweeter by two magnetic circuits that share similar components would reduce costs, increase magnet efficiency, as well as easing assembly complexity during manufacturing process.

Another advantage of the disclosed technology is placement of the radial location of the geometrical separating feature is optionally done according to the desired split between the intensity of the magnetic flux of the first and the second magnetic circuits. The simple coaxial arrangement of the speaker driver, according to the disclosed technology, along with the advantage of time alignment between the woofer and the tweeter, can be utilized not only for loudspeakers but also for headphones and micro-drivers.

According to some embodiments, there is provided a speaker driver comprising a magnet having a magnet top portion, a magnet bottom portion, a magnet outer circumference and a magnet inner circumference. The speaker driver further comprises a woofer voice coil disposed around the magnet outer circumference, a tweeter voice coil disposed around the magnet inner circumference, and a top plate adjacent on a horizontal plane to the magnet. The top plate having a first plate portion and a second plate portion, separated by a geometrical separating feature, wherein the magnet is configured to generate a first magnetic flux passing through the first plate portion and the woofer voice coil and a second magnetic flux passing through the second plate portion and the tweeter voice coil. Wherein the location of the geometrical separating feature along the top plate is configured to influence the intensity of each of the first magnetic flux and the second magnetic flux.

According to some embodiments, the woofer voice coil comprises a woofer former and a woofer voice coil wire wound around the woofer former. Further, the tweeter voice coil comprises a tweeter former and a tweeter voice coil wire wound around the tweeter former, wherein the middle point along the vertical length of the woofer voice coil wire and the middle point along the vertical length of the tweeter voice coil wire are substantially in the same horizontal plane.

According to some embodiments, the separating geometrical feature is a circumferential recess.

According to some embodiments, the separating geometrical feature is located radially at the center of the top plate.

According to some embodiments, the geometrical separating feature is located radially closer to the magnet inner circumference than to the magnet outer circumference.

According to some embodiments, the magnet comprises neodymium.

According to some embodiments, the geometrical separating feature is protruding throughout the complete vertical height of the top plate, thereby spacing apart the first plate portion and the second plate portion.

According to some embodiments, the speaker driver further comprises a woofer diaphragm with a woofer surround, the woofer diaphragm connected to a chassis having a chassis rim, and a tweeter diaphragm with a tweeter surround. The tweeter diaphragm connected to a tweeter alignment component placed on top of the top plate, wherein the woofer former is attached to the woofer diaphragm and the tweeter former is attached to the tweeter diaphragm. Also, wherein the top plate comprises at least one plate recess, and wherein the tweeter alignment component further comprises at least one alignment protrusion, configured to be accepted within the at least one plate recess, thereby aligning the tweeter alignment component and the top plate.

According to some embodiments, the speaker driver further comprises a chassis having a chassis base, a cup having a cup base and a cup sidewall (wherein the cup base is disposed on the chassis base and the woofer voice coil is disposed within a first gap, formed between the cup sidewall and the magnet outer circumference), and a yoke having a bottom yoke and a center pole (wherein the bottom yoke is disposed on the cup base and the tweeter voice coil is disposed within a second gap, formed between the center pole and the magnet inner circumference). Wherein the first magnetic flux runs from the magnet to the first plate portion, the first gap passing through the woofer voice coil, the cup sidewall, the cup base, the yoke bottom and back to the magnet, and wherein the second magnetic flux runs from the magnet to the second plate portion, the second gap passing through the tweeter voice coil, the central pole, the bottom yoke and back to the magnet.

According to some embodiments, the yoke base further comprises a yoke geometrical separating feature.

According to some embodiments, the cup further comprises a cup cable aperture, the yoke further comprises a yoke cable aperture, the magnet further comprises a magnet cable aperture, the top plate further comprises a top plate cable aperture and the tweeter alignment component further comprises a tweeter cable aperture. Wherein the cup cable aperture, the yoke cable aperture, the magnet cable aperture, the top plate cable aperture and the tweeter cable aperture are vertically aligned.

According to some embodiments, the speaker driver further comprises a chassis having a chassis base, and a cup yoke (the cup yoke having a center pole, a first yoke base portion having an upper surface, a second yoke base portion having an upper surface, and a cup yoke sidewall, wherein the upper surface of the first yoke base portion is vertically lower than the upper surface of the second yoke base portion, wherein the second yoke base portion is disposed on the chassis base, wherein the woofer voice coil is disposed within a first gap formed between the cup yoke sidewall and the magnet outer circumference, and wherein the tweeter voice coil is disposed within a second gap formed between the center pole and the magnet inner circumference). Wherein the first magnetic flux runs from the magnet to the first plate portion, the first gap passing through the woofer voice coil, the cup yoke sidewall, the second yoke base, the first yoke base and back to the magnet, and wherein the second magnetic flux runs from the magnet to the second plate portion, the second gap passing through the tweeter voice coil, the central pole, the first yoke base and back to the magnet.

According to some embodiments, the second yoke base portion further comprises a yoke geometrical separating feature. According to some embodiments, the cup yoke further comprises a cup yoke cable aperture, the magnet further comprises a magnet cable aperture, the top plate further comprises a top plate cable aperture and the tweeter alignment component further comprises a tweeter cable aperture. Wherein the cup cable aperture, the yoke cable aperture, the magnet cable aperture, the top plate cable aperture and the tweeter cable aperture are vertically aligned.

According to some embodiments, the speaker driver further comprises a spider.

According to some embodiments, the spider comprises a spider corrugation portion having spider outer circumferential portion, a spider rising portion, a spider neck portion, and at least one reinforcement rib, extending from at least a portion of the spider rising portion to at least a portion of the spider neck portion. Wherein the spider corrugation portion, the spider rising portion and the spider neck portion are formed as a single composite piece, and wherein the spider is attached to the chassis via the spider outer circumferential portion, and to the woofer voice coil and the woofer diaphragm via the spider neck portion.

Certain embodiments of the present invention may include some, all, or none of the above advantages. Further advantages may be readily apparent to those skilled in the art from the figures, descriptions, and claims included herein. Aspects and embodiments of the invention are further described in the specification herein below and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 constitutes an exploded view in perspective of components of a speaker driver, according to some embodiments.

FIG. 2 constitutes a cut-away view in perspective of a speaker driver, according to some embodiments.

FIG. 3 constitutes a cross-sectional view of a speaker driver, according to some embodiments.

FIG. 4 constitutes a cross-sectional view of a subassembly of a speaker driver, according to some embodiments.

FIG. 5a constitutes a cross-sectional view depicting magnetic flux through a subassembly of a speaker driver, according to some embodiments.

FIG. 5b constitutes a cross-sectional view depicting magnetic flux through a subassembly of a speaker driver, according to some embodiments.

FIG. 5c constitutes a cross-sectional view depicting magnetic flux through a subassembly of a speaker driver, according to some embodiments.

FIG. 5d constitutes a cross-sectional view depicting magnetic flux through a subassembly of a speaker driver, according to some embodiments.

FIG. 6a constitutes a view in perspective of a spider, according to some embodiments.

FIG. 6b constitutes a top-view of a spider, according to some embodiments.

FIG. 6c constitutes a cross-sectional view of a spider taken on line 6c-6c of FIG. 6b, according to some embodiments.

FIG. 6d constitutes an enlarged view of a spider taken on region 6d of FIG. 6c, according to some embodiments.

FIG. 7a constitutes a view in perspective of a spider, according to some embodiments.

FIG. 7b constitutes a top-view of a spider, according to some embodiments.

FIG. 7c constitutes a cross-sectional view of a spider taken on line 7c-7c of FIG. 7b, according to some embodiments.

FIG. 7d constitutes an enlarged view of a spider taken on region 7d of FIG. 7c, according to some embodiments.

FIG. 8a constitutes a view in perspective of a spider, according to some embodiments.

FIG. 8b constitutes a top-view of a spider, according to some embodiments.

FIG. 8c constitutes a cross-sectional view of a spider taken on line 8c-8c of FIG. 8b, according to some embodiments.

FIG. 8d constitutes an enlarged view of region 8d marked in FIG. 8c, according to some embodiments.

FIG. 9a constitutes a view in perspective of a tweeter alignment component, taken from a top-side angle, according to some embodiments.

FIG. 9b constitutes a view in perspective of a tweeter alignment component, taken from a bottom-side angle, according to some embodiments.

FIG. 9c constitutes a top-view of a tweeter alignment component, according to some embodiments.

FIG. 9d constitutes a side-view of a tweeter alignment component, according to some embodiments.

FIG. 10a constitutes an exploded view in perspective of a tweeter alignment component and a top plate, according to some embodiments.

FIG. 10b constitutes a top-view of a tweeter alignment component and a top plate subassembly, according to some embodiments.

FIG. 10c constitutes a cross-sectional view of a tweeter alignment component and a top plate subassembly taken on line 10c-10c of FIG. 10b, according to some embodiments.

FIG. 11a constitutes a cross-sectional view of a speaker driver, according to some embodiments.

FIG. 11b constitutes an enlarged view of region 11b marked in FIG. 11a, according to some embodiments.

FIG. 12a constitutes a cross-sectional view of a speaker driver with a tweeter cable, according to some embodiments.

FIG. 12b constitutes an enlarged view of region 12b marked in FIG. 12a, according to some embodiments.

FIG. 13 constitutes a cross-sectional view of a speaker driver with a woofer cable, according to some embodiments.

FIG. 14a constitutes a view in perspective of a cup yoke, according to some embodiments.

FIG. 14b constitutes a top-view of a cup yoke, according to some embodiments.

FIG. 14c constitutes a cross-sectional view of a cup yoke taken on line 14c-14c of FIG. 14b, according to some embodiments.

### DETAILED DESCRIPTION OF SOME EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout.

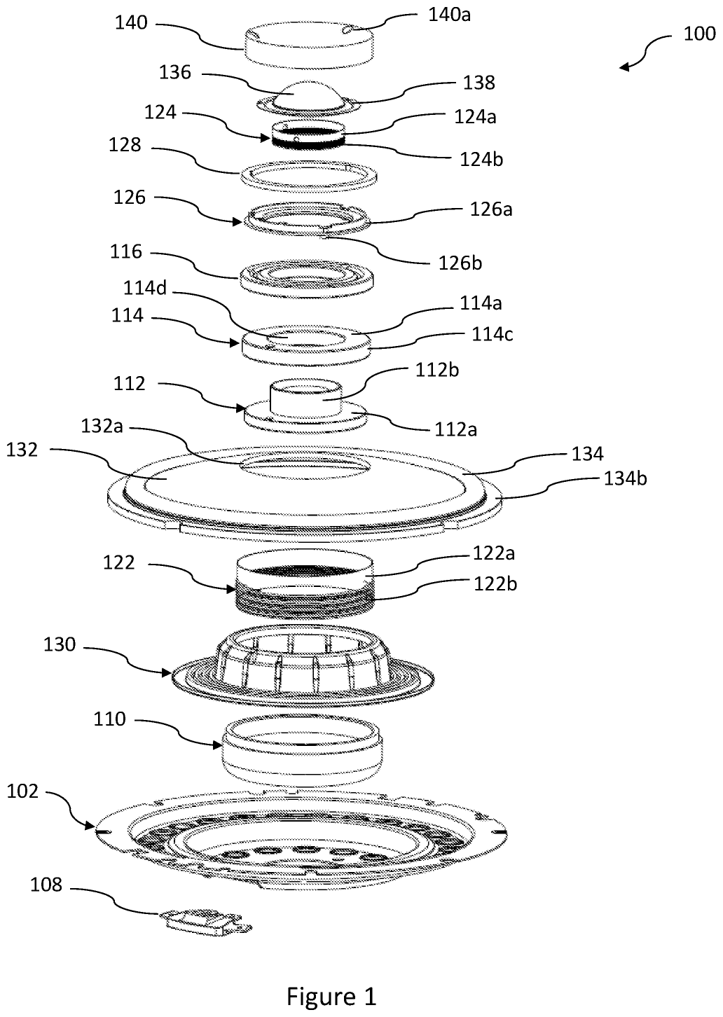

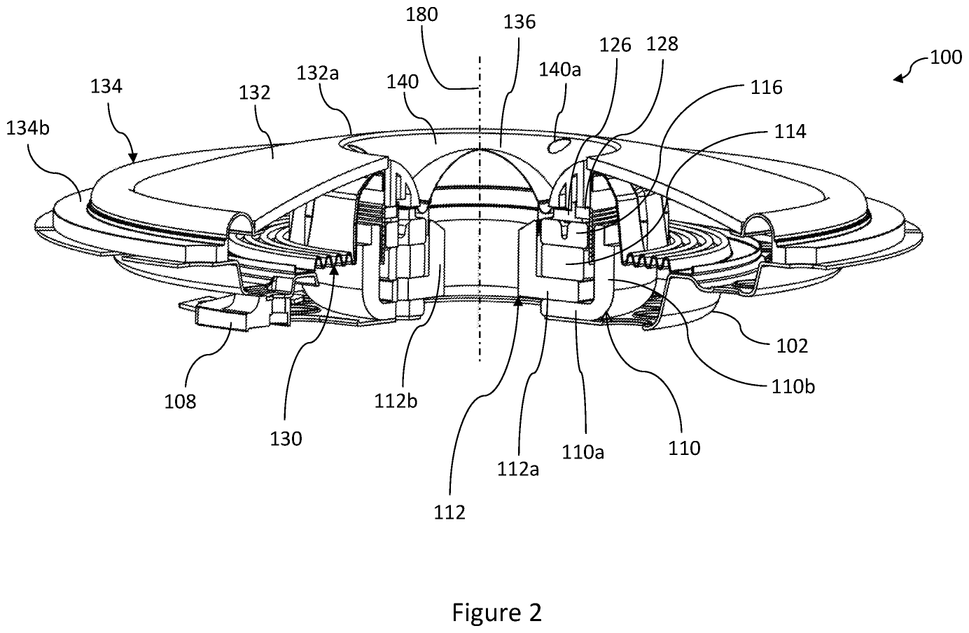

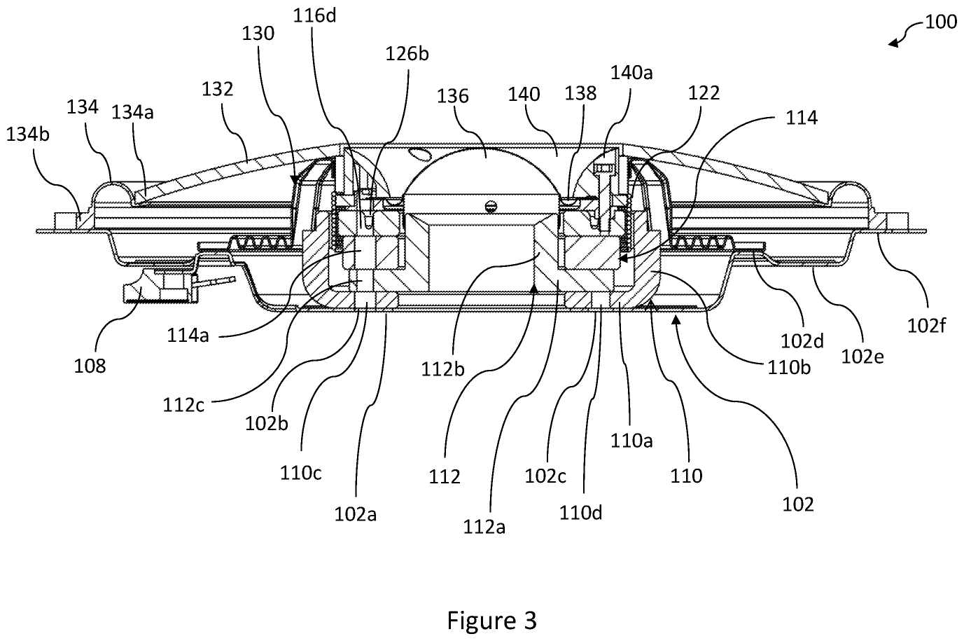

According to an aspect of some embodiments, there is provided a speaker driver 100. Reference is now made to FIGS. 1-5d. FIG. 1 constitutes an exploded view in perspective of components of speaker driver 100. FIGS. 2 and 3 constitute a cut-away view in perspective and a cross-sectional view, respectively, of speaker driver 100. Speaker driver 100, as disclosed herein, is supported by a chassis 102, also known as a basket or a frame, which has a chassis base 102a and a chassis rim 102f for supporting a woofer surround 134. Woofer surround 134 is attached on one end to a woofer diaphragm 132 via woofer surround lip 134a, and attached on the other end to chassis rim 102f via woofer surround rim 134b (see FIG. 3).

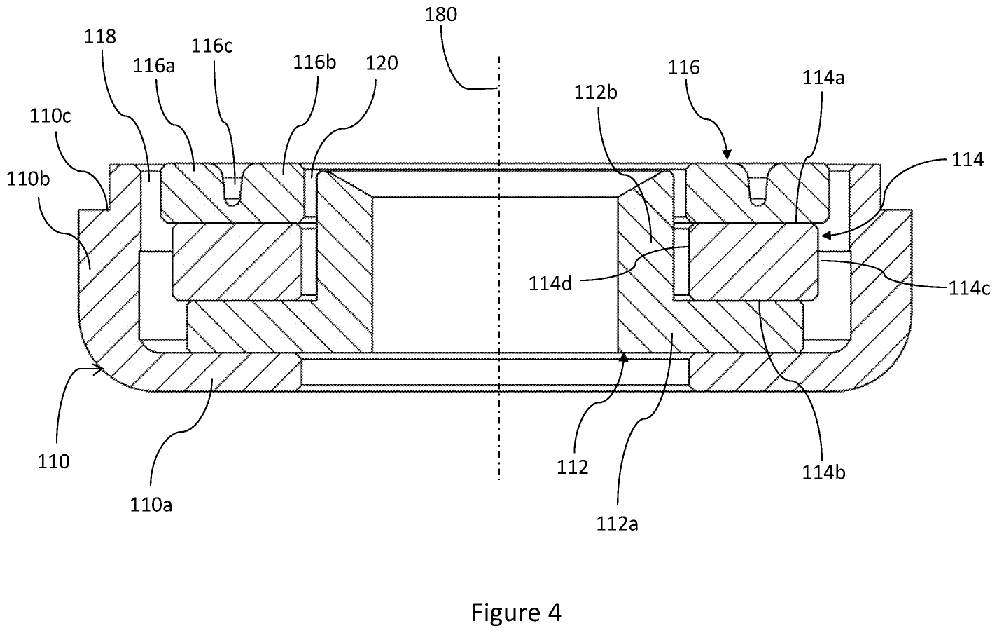

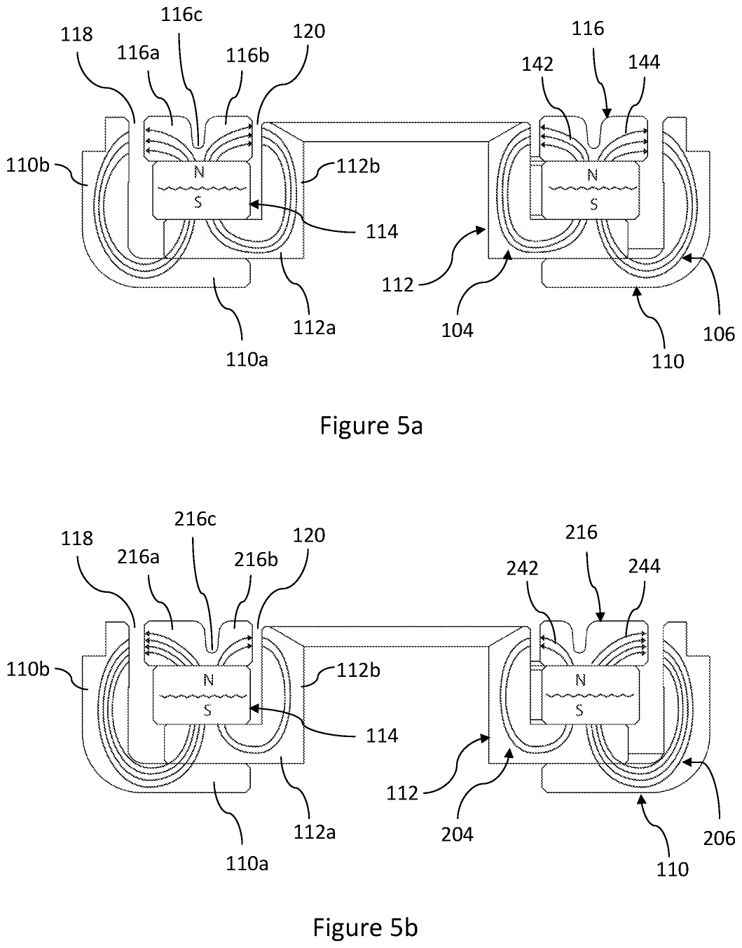

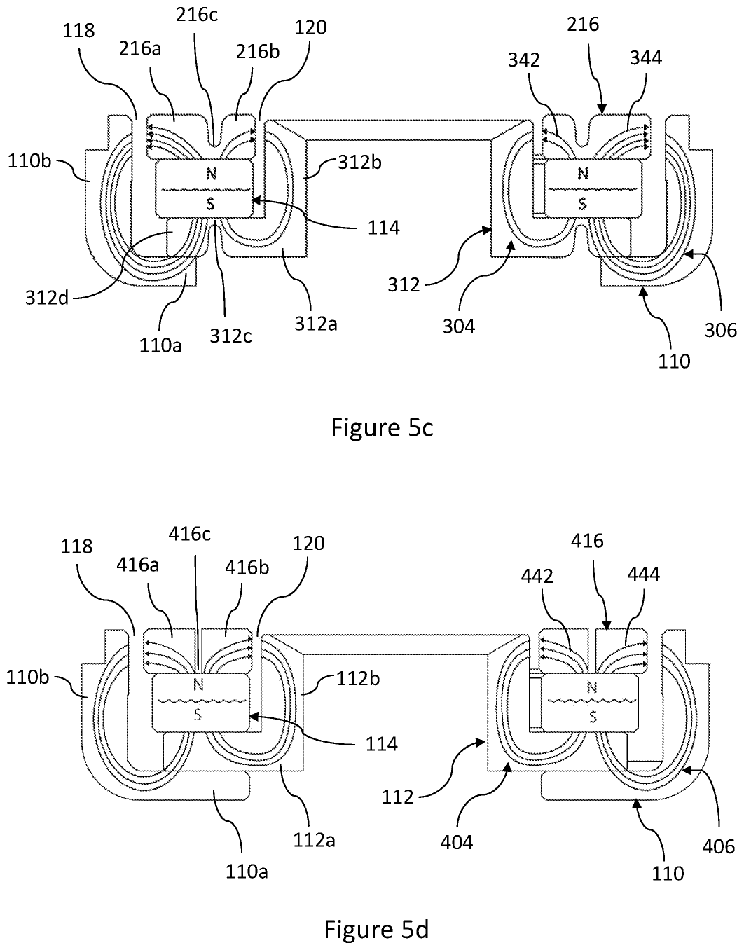

Chassis base 102a supports magnetic circuits 104 and 106 (indicated in FIGS. 5a-5d), both sharing a single magnet 114, and at least one magnetically permeable component. Magnetically permeable components include a woofer cup 110, a T-yoke 112 and a top-plate 116. Magnet 114 includes a magnet top portion 114a, a magnet bottom portion 114b, a magnet outer circumference 114c and a magnet inner circumference 114d (see FIGS. 1 and 4). Woofer cup 110, placed on top of chassis base 102a, is configured by two integral parts: a cup base 110a and a cup sidewall 110b extending from it. T-yoke 112, placed on top of woofer cup 110, includes a bottom yoke 112a extending to a center pole 112b.

The terms “yoke” and “T-yoke”, as used herein, are interchangeable.

Woofer diaphragm 132, configured to operate in a lower frequency band, is secured to a woofer voice coil 122. Tweeter diaphragm 136, configured to operate in a higher frequency band and provided with a tweeter voice coil 124, is arranged concentric to woofer diaphragm 132. Longitudinal axis 180 is preferably an axis of radial symmetry for woofer diaphragm 132 and tweeter diaphragm 136 and is the reference from which radial direction discussed below originates. Vertical direction, as used herein, is defined as the direction along longitudinal axis 180.

The term “low frequency band”, as used herein, refers to any frequency range between the boundaries of 20-10,000 Hz, such as, for example, a range of 40-2,000 Hz.

The term “high frequency band”, as used herein, refers to any frequency range between the boundaries of 1,000-120,000 Hz, such as, for example, a range of 2,000-20,000 Hz.

According to some embodiments, top plate 116 is adjacent on a horizontal plane to magnet 114, such as the horizontal plane of magnet top portion 114a or the horizontal plane of magnet bottom portion 114b. According to some embodiments (see FIGS. 1-4), magnet 114 is provided between top plate 116 and yoke 112, such that top plate 116 is adjacent on a horizontal plane of magnet top portion 114a, and bottom yoke 112a is adjacent on a horizontal plane to magnet bottom portion 114b. Top plate 116 is separated from cup sidewall 110b by a first gap 118, and from center pole 112b by a second gap 120, respectively (See FIG. 4).

Woofer voice coil 122 is disposed within first gap 118 around magnet outer circumference 114c. Woofer voice coil 122 includes a woofer voice coil wire 122b wound around a woofer former 122a. Tweeter voice coil 124 is disposed within second gap 120 around magnet inner circumference 114d. Tweeter voice coil 124 includes a tweeter voice coil wire 124b wound around a tweeter former 124a. Woofer voice coil 122 and tweeter voice coil 124 are sized and arranged to enable vertical movement of woofer former 122a and tweeter former 124a within first gap 118 and second gap 120, respectively.

The term “horizontal plane”, as used herein, refers to a plane perpendicular to longitudinal axis 180,

The term “adjacent on a horizontal plane”, as used herein, more specifically refers to a first component being adjacent on a horizontal plane to a second component, such that a surface of the first component is in contact with a surface of the second component, the surface of the second component defining the horizontal plane of contact.

It is preferred that each of chassis 102, woofer cup 110, spider 130, T-yoke 112, magnet 114 and top plate 116 are ring shaped. However, it is to be understood that any or each of the components fulfill the function when otherwise shaped, as in a rectangle, triangle, rhombus, parallelogram, oval, star, pentagon, hexagon, octagon, or other polygon.

It is preferred that each one of chassis 102, woofer cup 110, spider 130, T-yoke 112, magnet 114 and top plate 116 is formed as a single integral component. However, it is to be understood that any or each of the components fulfill the function when formed from several parts combined together to form the component.

According to some embodiments, woofer voice coil 122 and tweeter voice coil 124 are horizontally aligned, such that the middle point along the vertical length of woofer voice coil wire 122b and the middle point along the vertical length of tweeter voice coil wire 124b are substantially in the same horizontal plane. Advantageously, this arrangement provides time-alignment between woofer voice coil 122 and tweeter voice coil 124, thereby providing better acoustic performance of speaker driver 100. Moreover, the overall configuration of speaker driver 100, with special emphasis on time alignment between woofer voice coil 122 and tweeter voice coil 124, enable such arrangement to be utilized not only for loudspeakers but also for headphones, providing a simple time-aligned technological solution to cover both low (woofer) and high (tweeter) frequency ranges without compromising acoustic performance.

According to some embodiments, woofer voice coil 122 and tweeter voice coil 124 are not aligned horizontally, such that the middle point along the vertical length of woofer voice coil wire 122b and the middle point along the vertical length of tweeter voice coil wire 124b are not positioned substantially in the same horizontal plane.

The term “substantially in the same horizontal plane”, as used herein, refers to being at the same vertical height along longitudinal axis 180, or being at heights that vertically do not deviate from one another more than 10% of the radial distance between the entities referred to as being substantially in the same horizontal plane.

The term “vertically aligned”, as used herein, refers to positioning of at least two elements in a manner that each element's axis of symmetry, parallel to longitudinal axis 180, is positioned at a substantially identical radial distance from longitudinal axis 180.

The term “substantially identical”, as used herein, means the same or deviates by no more than 10% from one another.

FIG. 4 constitutes a cross-section view of a subassembly of speaker driver 100. Top plate 116 is provided with a geometrical separating feature 116c. According to some embodiments, such as the embodiments illustrated in FIG. 4, geometrical separating feature 116c is configured as a circumferential recess, separating between a first plate portion 116a and a second plate portion 116b. The cross-sectional shape of geometrical separating feature 116c is illustrated in FIG. 4 as a recess having a dome-shaped socket in the middle, extending to a rectangular cross section formed with corresponding slopes tapered vertically towards the direction of woofer diaphragm 132, either radially outwards when extending towards first plate portion 116a, or radially inwards when extending towards second plate portion 116b. It is to be understood, however, that the cross-sectional geometry of geometrical separating feature 116c is optionally different, such as a circular, triangular or any other curvilinear or rectilinear cross-section.

Reference is now made to FIG. 5a-5d. FIG. 5a-5d constitute a cross-sectional view depicting magnetic flux through different embodiments of components of the subassembly presented in FIG. 4. FIGS. 5a-5d are provided without section hatching lines for ease in viewing and understanding the schematic depiction of magnetic flux lines. Both first magnet circuit 104 and second magnet circuit 106 are defined by the same magnet 114, in two opposite directions as depicted in FIG. 5a. First flux lines 142 of first magnet circuit 104 flow from the north pole of magnet 114 to first plate portion 116a, on towards first gap 118, through cup sidewall 110b and cup base 110a of woofer cup 110, on to bottom yoke 112a and finally to the south pole of magnet 114. Second flux lines 144 of second magnet circuit 106 flow from the north pole of magnet 114 to second plate portion 116b, passing through second gap 120 towards center pole 112b and bottom yoke 112a of T-yoke 112, on to the south pole of magnet 114.

Advantageously, geometrical separating feature 116c concentrates first flux lines 142 and second flux lines 144 passing through first plate portion 116a and second plate portion 116b, respectively, allowing for increased magnetic flux efficiency.

Another advantage of geometrical separating feature 116c is that the intensity of the magnetic field in first 104 and second 106 magnet circuits is changed by the radial location of geometrical separating feature 116c along top plate 116. While FIG. 5a presents an embodiment of top plate 116 wherein geometrical separating feature 116c is radially located at the middle of top plate 116. FIG. 5b illustrates another embodiment of top plate 216 in which geometrical separating feature 216c, separating between first plate portion 216a and second plate portion 216b, is located radially closer to second air gap 120.

The amount of the illustrated flux lines is representative of the intensity of the magnetic field in each magnetic circuit, such that a configuration of the embodiment illustrated in FIG. 5b results in a stronger magnetic field, as indicated by a higher amount of illustrated first flux lines 242, passing through first magnet circuit 204, than the magnetic field of second magnet circuit 206, as indicated by a lower amount of illustrated second flux lines 242, passing there through. In this configuration, a greater amount of the magnetic field is passing through first gap 118 than through second gap 120. Thus, the radial position of geometrical separating feature 216c is optionally configured, during a manufacturing process, according to a desired split of magnetic field intensity between first gap 118, within which woofer voice coil 122 is suspended, and second gap 120, within which tweeter voice coil 124 is suspended.

FIG. 5c illustrates yet another embodiment which differs from the embodiments of FIG. 5b in that T-yoke 112 is replace by T-yoke 312, comprising a bottom yoke 312a and a center pole 312b. Bottom yoke 312a differs from bottom yoke 112a in that it includes a yoke geometrical separating feature 312c, vertically aligned with geometrical separating feature 216c of top plate 216. According to some embodiments, the cross-sectional geometry of geometrical separating feature 312c is similar to that of geometrical separating feature 216c, except that the profile of the former is vertically inverted, having its open end facing chassis base 102a.

According to some embodiments, the cross-sectional geometry of geometrical separating feature 312c differs from that of geometrical separating feature 216c. First flux lines 342 of first magnet circuit 304 flow from the north pole of magnet 114 to first plate portion 216a, on towards first gap 118, through cup sidewall 110b and cup base 110a of woofer cup 110, on to bottom yoke 312a and finally to the south pole of magnet 114. Second flux lines 344 of second magnet circuit 306 flow from the north pole of magnet 114 to second plate portion 216b, passing through second gap 120 towards center pole 312b and bottom yoke 312a of T-yoke 312, on to the south pole of magnet 114.

Advantageously, geometrical separating feature 312c further contributes to focusing and adjusting the magnetic flux intensity of each of magnetic circuits 304 and 306. According to some embodiments, magnetic circuits 304 and 306 include T-yoke 312 and top-plate 116, such that yoke geometrical separating feature 312c is vertically aligned with geometrical separating feature 116c. According to some embodiments, magnetic circuits 304 and 306 include T-yoke 312 and a top plate that does not include a geometrical separating feature (not shown), such that focusing and adjusting the intensity of each of magnetic circuits 304 and 306 is achieved solely due to yoke geometrical separating feature 312c, and not due to a top-plate having both upper and lower surfaces substantially flat.

FIG. 5d illustrates yet another embodiment which differs from the embodiment of FIG. 5a in that upper plate 116 is replaced by upper plate assembly 416, having first upper plate 416a and second upper plate 416b divided by a top-plate separation gap 416c. First flux lines 442 of first magnet circuit 404 flow from the north pole of magnet 114 to first upper plate 416a, on towards first gap 118, through cup sidewall 110b and cup base 110a of woofer cup 110, on to bottom yoke 112a and finally to the south pole of magnet 114. Second flux lines 444 of second magnet circuit 406 flow from the north pole of magnet 114 to s second upper plate 416b, passing through second gap 120 towards center pole 112b and bottom yoke 112a of T-yoke 112, on to the south pole of magnet 114. According to some embodiments, radial location of top-plate separation gap 416c differ, influencing the radial dimensions of first upper plate 416a and second upper plate 416b so as to adjust the intensity of each of magnetic circuits 404 and 406.

It is understood that the schematic depiction of magnetic flux lines in FIGS. 5a-5d are for purposes of explanation only and that varying and/or additional flux lines may be present.

According to some embodiments, magnet 114 is a permanent magnet, such as, but not limited to, ceramic, ferrite or Alnico magnets.

According to some embodiments, magnet 114 is a neodymium magnet (NdFe35). Neodymium creates a strong magnetic field using a smaller volume of material as compared to ferrite, for example, and has a high mechanical strength to sufficiently prevent breakage thereof. Advantageously, using neodymium results in a smaller volume required for magnet 114, compared to ferrite, to generate the same magnetic flux. Advantageously, using a neodymium magnet saves space, allowing it to be incorporated within a shallow driver 100, which allow mounting in a narrow spaces, such as the inside of vehicles. Moreover, the mechanical strength provided by neodymium enables magnet 114 to be provided, according to some embodiments, with magnet cable aperture 114e, without risking breakage of magnet 114 as a result.

Advantageously, the inclusion of woofer cup 110 as an additional magnetically permeable component in second magnet circuit 106 (as well as other embodiments of second magnet circuit 206, 306, 406), in addition to top plate 116 and T-yoke 112, allows for a more efficient utilization of magnetic flux generated by a neodymium magnet 114, compared to a magnet circuit absent of woofer cup 110.

The vertical height (not numbered) of first gap 118 is configured to allow vertical displacements of woofer voice coil 122 without hitting cup base 110a. The vertical height (not numbered) of second gap 120 is configured to allow vertical displacements of tweeter voice coil 122 without hitting bottom yoke 112a. According to some embodiments, the vertical height of first gap 118 is higher than the vertical height of second gap 120, thereby allowing for a larger vertical displacement of woofer voice coil 122 than that of tweeter voice coil 124.

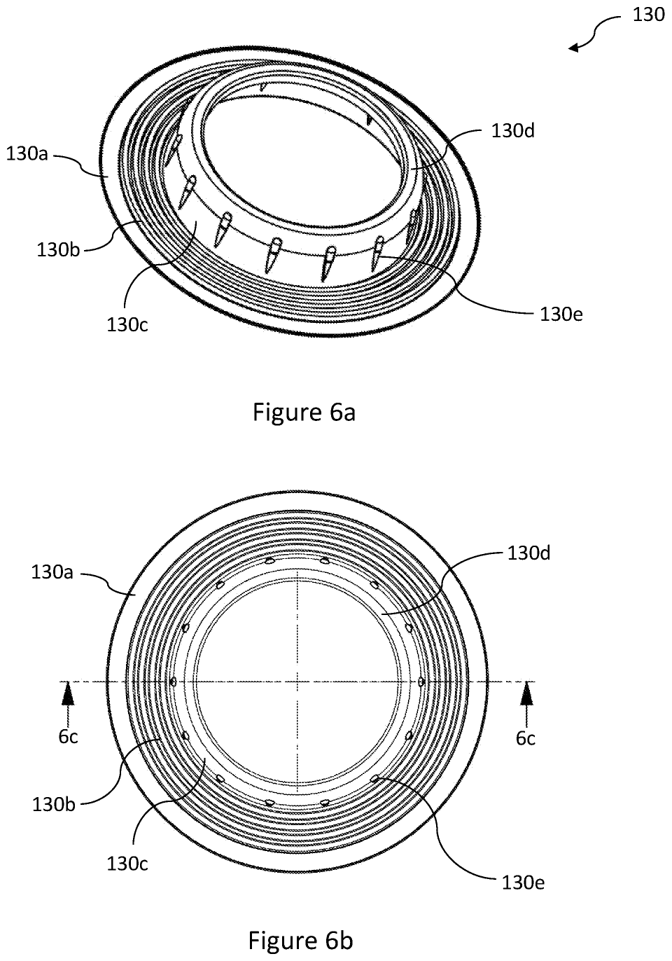

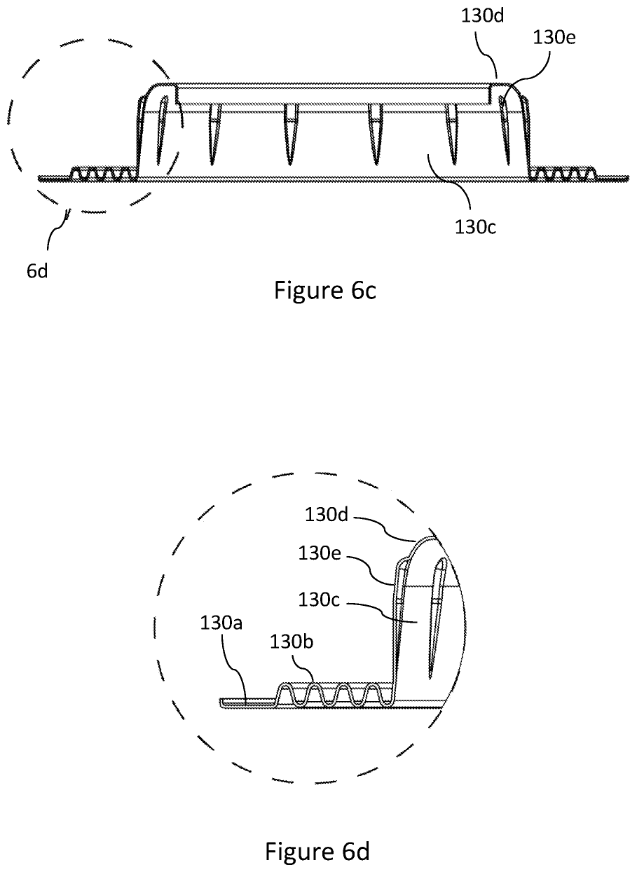

Reference is now made to FIGS. 6a-6d. FIGS. 6a and 6b constitute a view in perspective and a top-view, respectively, of a spider 130, according to some embodiments. FIG. 6c constitutes a cross-sectional view of spider 130 taken on line 6c-6c of FIG. 6b. FIG. 6d constitutes an enlarged view of spider 130 taken on region 6d of FIG. 6c. Spider 130 includes a spider corrugation portion 130b having a spider outer circumferential portion 130a on one end, and extending to a spider rising portion 130c on the other end. Spider rising portion 130c further extends to a spider neck portion 130d. A plurality of reinforcing ribs 130e are circumferentially arranged around spider rising portion 130b, extending in the vertical direction along at least a portion of the vertical length of rising portion 130b and at least a portion of the radial length of spider neck portion 130d. Spider neck portion 130d is attached to both woofer former 122a and woofer diaphragm 132, while spider corrugation portion 130b is attached, via spider outer circumferential portion 130a, to chassis 102.

Advantageously, reinforcing ribs 130e provide spider neck portion 130d and spider rising portion 130c more resistance to flexing during movements of woofer diaphragm 136 and woofer former 122a in the vertical as well as radial directions. Spider corrugation portion 130b includes a plurality of radially undulate circumferential corrugations (not numbered), which provide for radial expansion and contraction of the spider 130. According to some embodiments, spider corrugation portion 130b, spider rising portion 130c and spider neck portion 130d are formed integrally and not as separate pieces that are later connected. According to some embodiments, spider outer circumferential portion 130a is a straight horizontal portion extending from the outermost radial corrugation, configured for attachment to chassis first ledge 102d.

The term “plurality”, as used herein, means more than one.

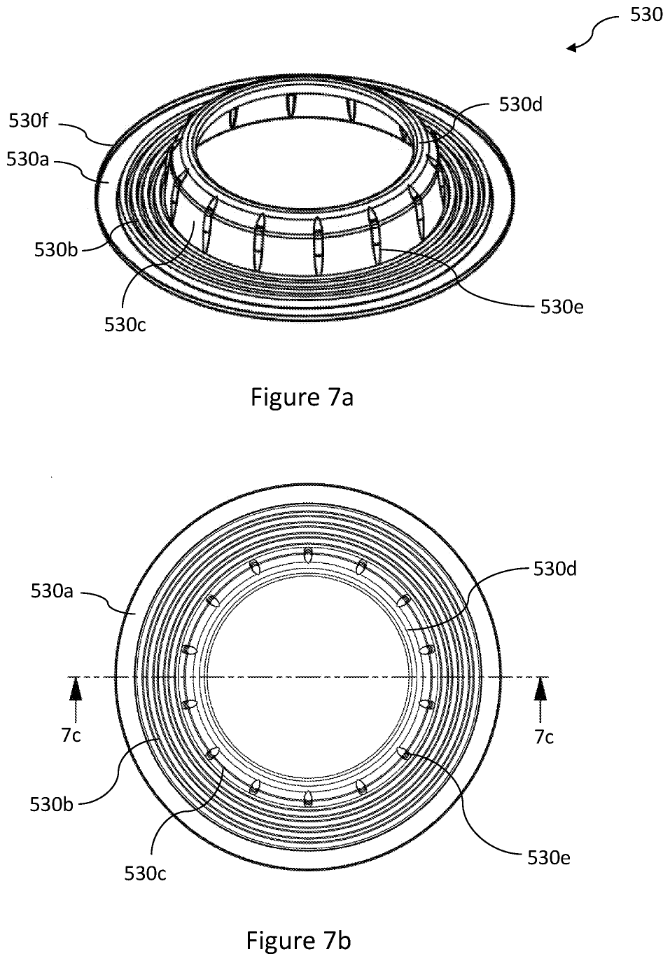

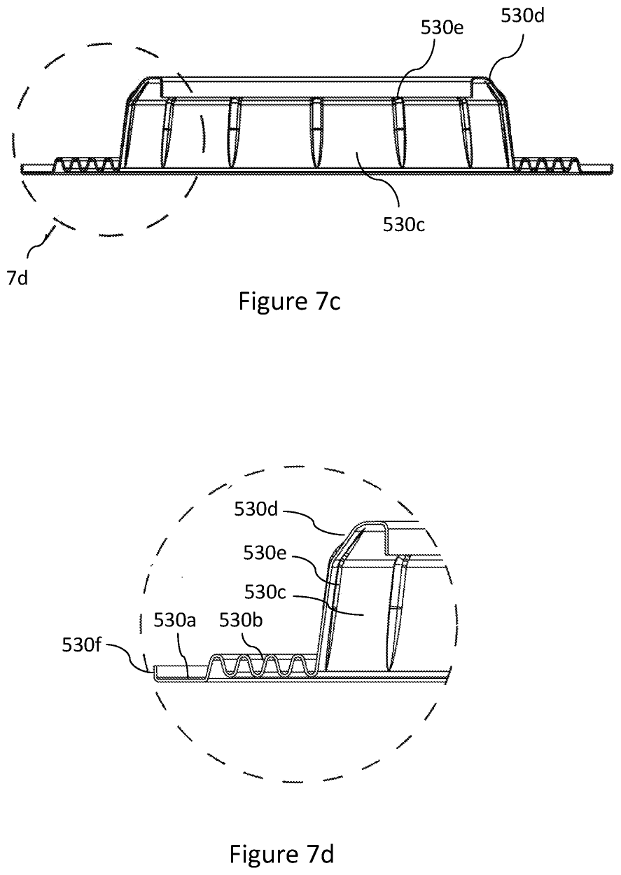

Reference is now made to FIGS. 7a-7d, illustrating another embodiment of a spider 530. FIGS. 7a and 7b constitute a view in perspective and a top-view, respectively, of spider 530. FIG. 7c constitutes a cross-sectional view of spider 530 taken on line 7c-7c of FIG. 7b. FIG. 7d constitutes an enlarged view of spider 530 taken on region 7d of FIG. 7c. Similarly to spider 130 illustrated in FIGS. 7a-7d, spider 530 comprises a spider corrugation portion 530b having a spider outer circumferential portion 530a on one end, and extending to a spider rising portion 530c on the other end. Spider rising portion 530c further extends to a spider neck portion 530d, and further comprises a plurality of reinforcing ribs 530e, circumferentially arranged around spider rising portion 530b.

According to some embodiments, reinforcing ribs 530e are extending from the edge of connection (not numbered) between spider corrugation portion 530b and spider rising portion 530c, and cover a longer length in the radial direction, originating from the edge of connection (not numbered) between spider rising portion 530c and spider neck portion 530d. According to some embodiments, the outer edge of spider outer circumferential portion 530a further comprises an extension 530f in the vertical direction.

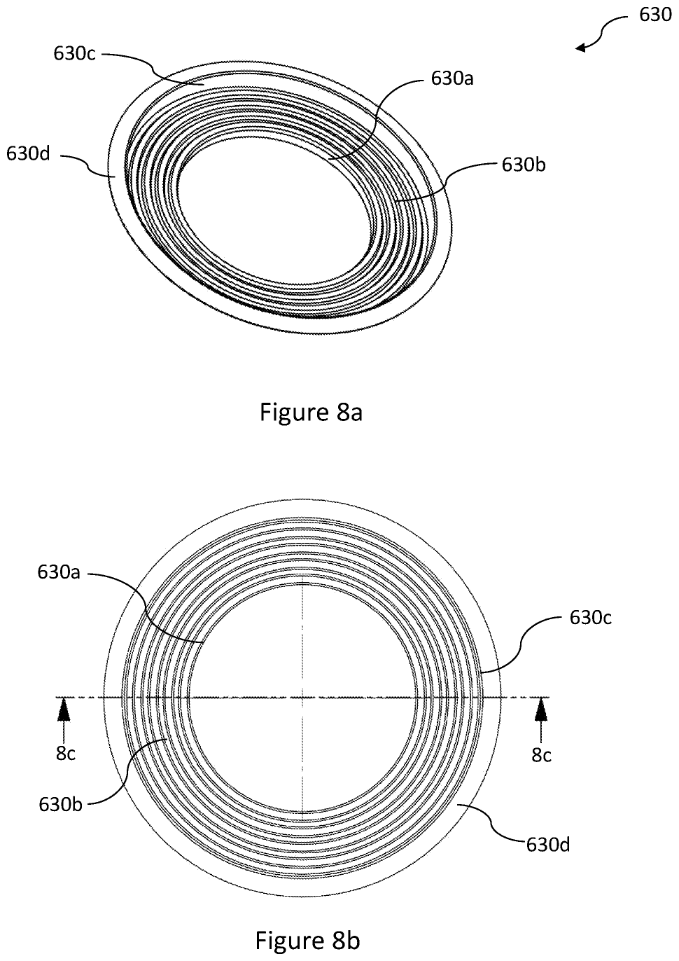

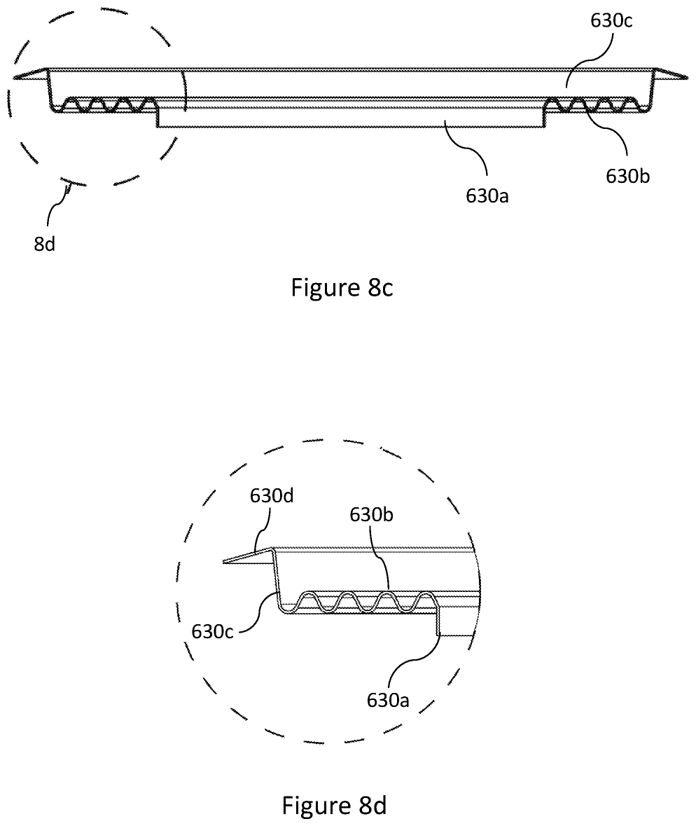

Reference is now made to FIGS. 8a-8d, illustrating yet another embodiment of a spider 630. FIGS. 8a and 8b constitute a view in perspective and a top-view, respectively, of spider 630. FIG. 8c constitutes a cross-sectional view of spider 630 taken on line 8c-8c of FIG. 8b. FIG. 8d constitutes an enlarged view of spider 630 taken on region 8d of FIG. 8c. Spider 630 comprises a spider corrugation portion 630b having a spider inner circumferential portion 630a on one end, and extending to a spider rising portion 630c on the other end. Spider rising portion 630c further extends to spider neck portion 630d. Spider neck portion 130d is configured for attachment to woofer diaphragm 132, while spider outer circumferential portion is configured for attachment to woofer cup 110. Spider corrugation portion 630b includes a plurality of radially undulate circumferential corrugations (not numbered), which provide for radial expansion and contraction of the spider 630.

According to some embodiments, spider corrugation portion 630b, spider rising portion 630c and spider neck portion 630d are formed integrally and not as separate pieces that are later connected. According to some embodiments, spider outer circumferential portion 630a is a straight vertical portion extending from the innermost radial corrugation, configured for attachment to cup sidewall 110b. According to some embodiments, said attachment is achieved by adhering vertical spider outer circumferential portion 630a to cup sidewall 110b.

According to some embodiments of the speaker driver 100, reference in this specification to any embodiment of a spider refers to spider embodiments 130, 530 and 630 and spider embodiments old and well known in the art.

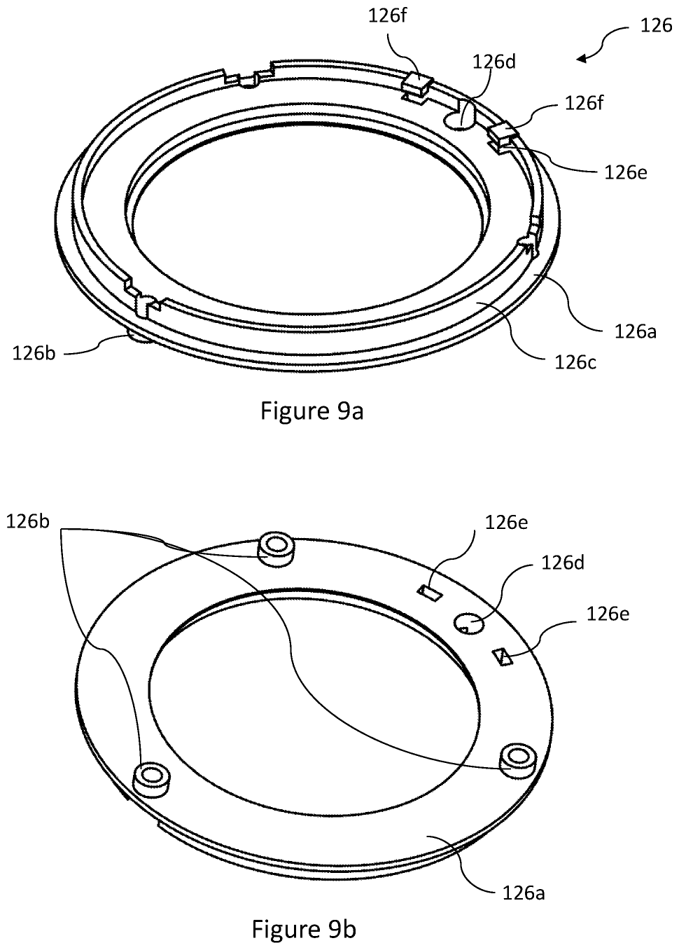

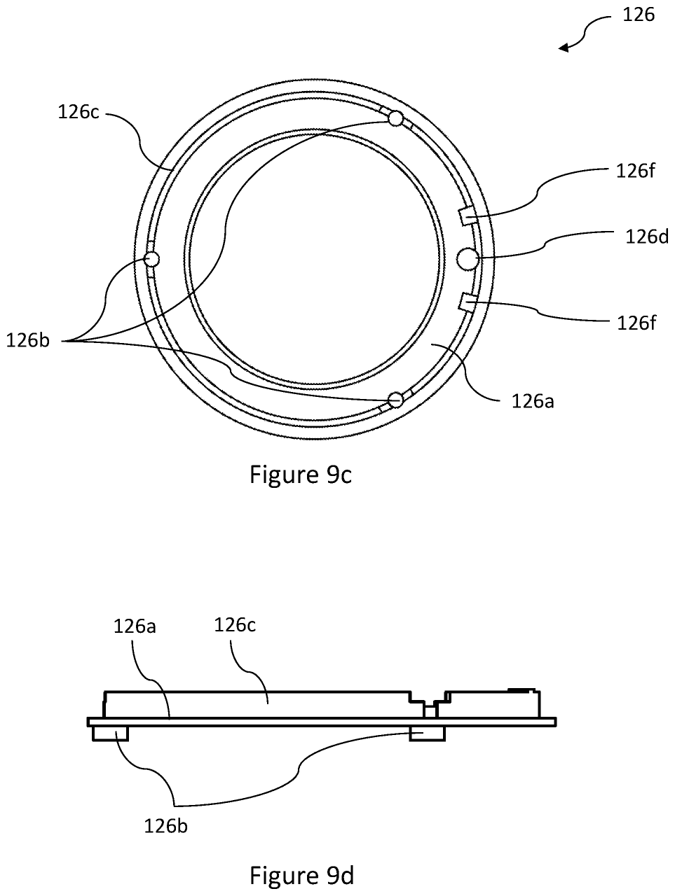

Reference is now made to FIGS. 9a-9d. FIGS. 9a and 9b constitute views in perspective of a tweeter alignment component 126, taken from a top-side angle and from a bottom-side angel, respectively, according to some embodiments. FIGS. 9c and 9d constitute a top-view and a side-view of tweeter alignment component 126, respectively. Tweeter alignment component 126 includes a tweeter alignment base 126a, an alignment circumferential extension 126c extending circumferentially from tweeter alignment base 126a upwards in the vertical direction, and at least one tweeter alignment protrusion 126b protruding from tweeter alignment base 126a downwards in the vertical direction.

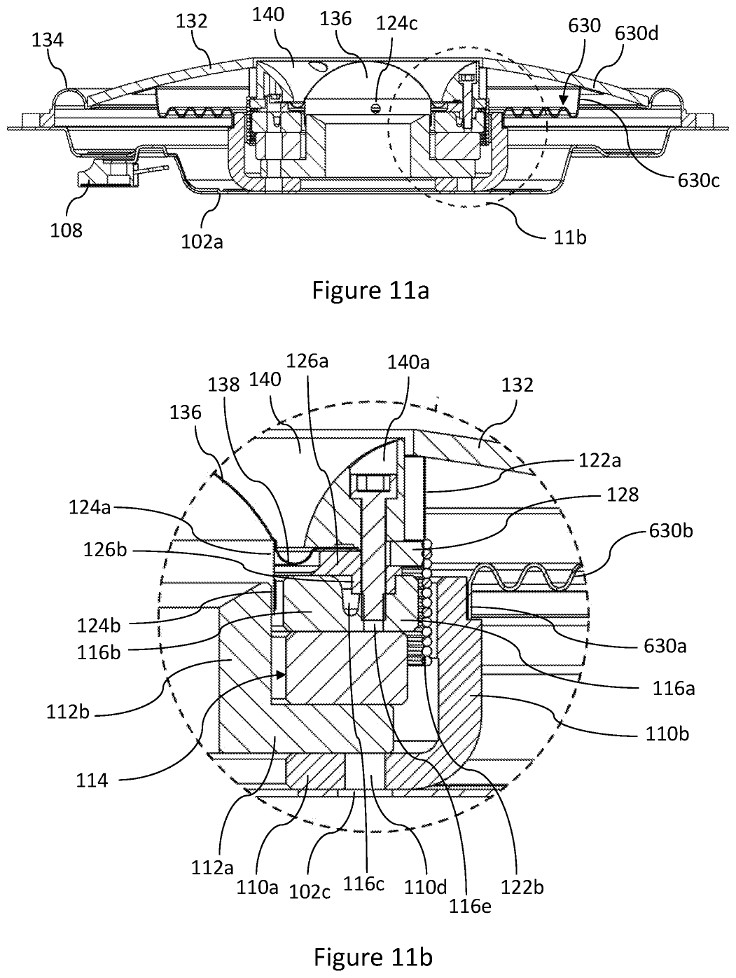

According to some embodiments, a plurality of tweeter alignment protrusions 126b are evenly spaced around tweeter alignment base 126a. According to some embodiments, each tweeter alignment protrusion 126b includes a threaded aperture (not numbered) configured to receive a threaded fastener, such as a bolt (shown by not numbered in FIGS. 11a-11b), the threaded aperture further extends through alignment circumferential extension 126c in the vertical direction. According to some embodiments, alignment circumferential extension 126c further includes a recess around the upper portion of said threaded aperture, adapted to match geometrically matching features (not shown) of a tweeter horn 140, for alignment between tweeter alignment component 126 and tweeter horn 140.

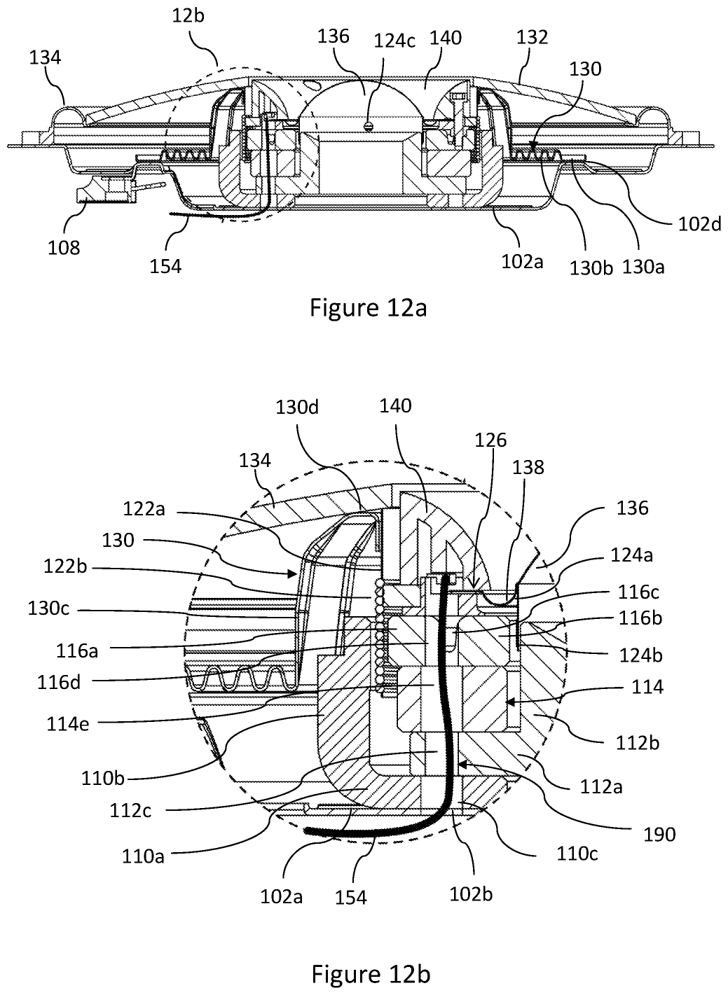

According to some embodiments, tweeter alignment base 126a and alignment circumferential extension 126c include a tweeter cable aperture 126d, adapted to receive a tweeter cable 154 (indicated in FIGS. 12a-12b). According to some embodiments, tweeter cable 154 includes at least two tweeter electric wires (not shown), branched out from tweeter cable 154 to at least one tweeter wire fastener 126f, seated on the upper edge of alignment circumferential extension 126c, further extending towards tweeter voice coil 124 through at least one tweeter wire opening 126e passing through tweeter alignment base 126a.

While an embodiment of tweeter alignment component 126 is illustrated in FIGS. 9a-9d with three tubular alignment circumferential extensions 126c, it will be understood by those of skill in the art that the number of alignment circumferential extensions 126c vary to any other amount, at any location along tweeter alignment base 126a, and having any other geometrical shape, such as rectangular or triangular protrusions.

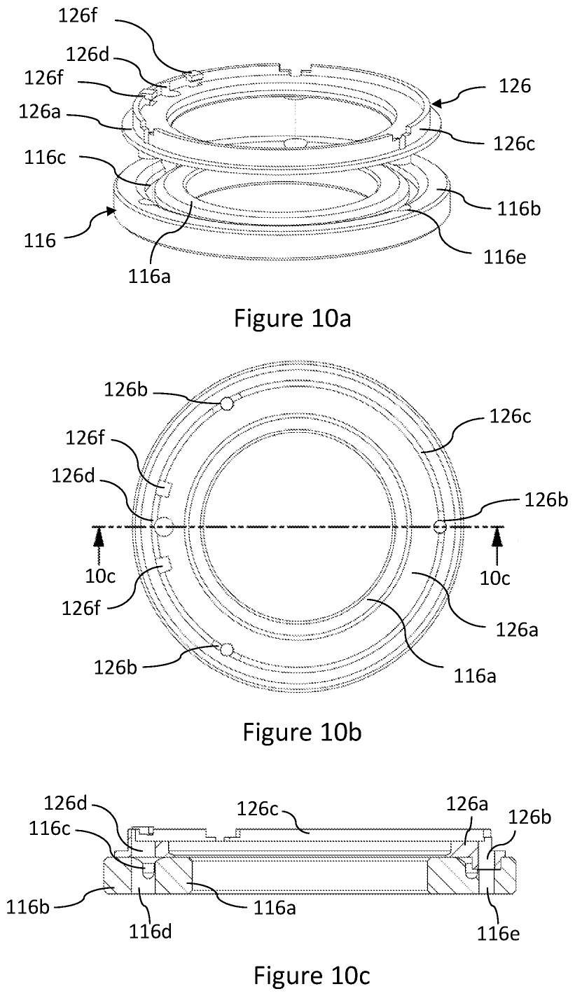

Reference is now made to FIGS. 10a-10c. FIGS. 10a and 10b constitute an exploded view in perspective and a top view, respectively, of tweeter alignment component 126 and top plate 116 subassembly, according to some embodiments. FIG. 10c constitutes a cross-sectional view of the tweeter alignment component 126 and top plate 116 subassembly taken on line 10c-10c of FIG. 10b. Top plate 116 includes at least one plate recess 116e, configured to receive the at least one tweeter alignment protrusion 126b. According to some embodiments, the number of plate recesses 116e is identical to the number of tweeter alignment protrusion 126b, and tweeter alignment component 126 is placed on top plate 116 such that each one tweeter alignment protrusion 126b is aligned with and inserted into a matching plate recess 116e.

According to some embodiments, each plate recess 116e includes a plate threaded aperture (not numbered). Whenever each tweeter alignment protrusion 126b is aligned with and inserted into plate recess 116e, a continuous threaded opening is formed between tweeter alignment protrusion 126b and plate recess 116e. The continuous threaded opening is configured to receive a threaded fastener, such as a bolt (shown by not numbered in FIGS. 11a-11b). According to some embodiments, top plate 116 further includes plate cable aperture 116d, so that when tweeter alignment component 126 is placed and aligned on top of top plate 116, tweeter cable aperture 126d is aligned with plate cable aperture 116d to form a continuous duct through which tweeter cable 154 can pass.

According to some embodiments, tweeter alignment protrusion 126b is formed as a continuous circular protrusion (not shown), following the entire circumference of tweeter alignment base 126a. The continuous circular protrusion is configured in its dimensions and shape so that when tweeter base 126 is placed on top of top plate 116, tweeter alignment protrusion 126b is accepted within geometrical separating feature 116c, thereby providing alignment as to limit the movement of tweeter alignment component 126 relative to top plate 116 in the radial direction. According to some embodiments, the cross-section of tweeter alignment protrusion 126b is substantially identical to the cross section of geometrical separating feature 116c.

According to some embodiments, the cross-section of tweeter alignment protrusion 126b matches only a portion of geometrical separating feature 116c, such that upon placement of tweeter alignment component 126 on top of top plate 116, the radial movement of the former is limited in the radial direction relative to the later. According to some embodiments, tweeter alignment component 126 is not provided with tweeter alignment protrusion 126b. According some embodiments, top plate 116 is provided with at least one ridge (not shown), and tweeter alignment component 126 is provided with at least one recess (not shown), such that the at least one recess is configured to match in its geometrical dimensions and shape the at least one ridge, thereby providing alignment between tweeter alignment component 126 and top plate 116 when the former is seated on the later.

Reference is now made to FIGS. 11a-11b. FIG. 11a constitutes a cross-sectional view of speaker driver 100 with spider 630, according to some embodiments. FIG. 11b constitutes an enlarged view of region 11b marked in FIG. 11a. Spider neck portion 630d is attached to woofer diaphragm 132, while spider outer circumferential portion 630a is attached to cup sidewall 110b. According to some embodiments, cup sidewall 110b includes a cup recess (not numbered) in its upper portion, configured to receive spider outer circumferential portion 630a.

Tweeter surround 138 connects between tweeter diaphragm 136 and tweeter alignment base 126a. Tweeter horn 140 is mounted on top of tweeter alignment base 126a, surrounding tweeter diaphragm 136. Tweeter horn 140 includes at least one tweeter horn opening 140a, substantially similar in its diameter to the aperture of the at least one tweeter alignment protrusions 126b, so that upon placement of tweeter horn on top of tweeter alignment component 126, each tweeter horn opening 140a is aligned with a corresponding tweeter alignment protrusions 126b.

According to some embodiments, the at least one tweeter horn opening 140a is threaded. According to some embodiments, the number of tweeter horn openings 140a matches the number of tweeter alignment protrusions 126b. At least one bolt (not numbered) is threaded through an at least one continuous threaded duct formed by each tweeter horn opening 140a, situated upon the aperture of a corresponding tweeter alignment protrusions 126b, situated in turn on top of a corresponding plate recess 116e.

According to some embodiments, tweeter former 124a includes at least one voice coil opening 124c, configured to dissipate potential resonance that can build up during regular operation of speaker driver 100.

Tweeter alignment base 126a supports absorption ring 128, configured to absorb a portion of the pressure waves that can build up within the space of second gap 120 during regular operation of speaker driver 100. According to some embodiments, absorption ring 128 is a felt ring. According to some embodiments, absorption ring 128 is formed as a spiral rope (not shown), having the advantage of not only absorbing a portion of the pressure waves, but also creating small air turbulences in the vicinity of the threaded strands of said rope, thereby further dissipating air pressure buildup.

According to some embodiments, chassis base 102a includes at least one chassis attachment opening 102c, and cup base 110a is threaded with at least one cup thread aperture 110d, such that the at least one chassis attachment opening 102c is vertically aligned with the at least one cup thread aperture 110d, together forming at least one insertion through-hole for at least one fastening unit (not shown). The at least one fastening unit can be a screw, a bolt, a rivet and the like.

Reference is now made to FIGS. 12a-12b. FIG. 12a constitutes a cross-sectional view of speaker driver 100 with spider 130 and tweeter cable 154, according to some embodiments. FIG. 12b constitutes an enlarged view of region 12b marked in FIG. 12a. Spider outer circumferential portion 130a is attached to chassis first ledge 102d, which is elevated in comparison to chassis second ledge 102e in the vertical direction. According to some embodiments, said attachment is achieved by adhering horizontal spider outer circumferential portion 130a to chassis second ledge 102e.

Preferably, the vertical height of chassis second ledge is configured to allow vertical displacement of woofer diaphragm 132. Preferably, the vertical height of chassis first ledge 102d is configured to match between the vertical length of spider rising portion 130d and the vertical space length of first gap 118, through which woofer voice coil 122 is allowed to displace in the vertical direction.

Spider neck portion 130d is formed, according to some embodiments, with at least three sections (not numbered). A vertical section in its radial innermost edge, configured for attachment to woofer former 122a. A horizontal section perpendicular to the vertical section, extending radially outwards therefrom, configured for attachment to woofer diaphragm 134. Finally, an angled section extending from the horizontal section to spider rising portion 130c, forming an obtuse angle between said horizontal section and said angled section. Advantageously, attaching spider 130 to all three components: chassis 102, woofer diaphragm 134 and woofer voice coil 122 improves stability and movement control of both woofer diaphragm 134 and woofer voice coil 122.

According to some embodiments, chassis base 102a, cup base 110a, bottom yoke 112a, magnet 114, top plate 116 and tweeter alignment component 126 are provided with chassis cable aperture 102b, cup cable aperture 110c, yoke cable aperturell2c, magnet cable aperture 114e, plate cable aperture 116d and tweeter cable aperture 126d, respectively. According to some embodiments, chassis cable aperture 102b, cup cable aperture 110c, yoke cable aperture 112c, magnet cable aperture 114e, plate cable aperture 116d and tweeter cable aperture 126d are aligned such that the center axis of each are vertically aligned, thereby forming a hollow passageway 190.

According to some embodiments, the diameter of each of chassis cable aperture 102b, cup cable aperture 110c, yoke cable aperture 112c, magnet cable aperture 114e, plate aperture 116d and tweeter cable aperture 126d is substantially identical, configured to allow passage of tweeter cable 154 there through. In some embodiments, the radial dimension of at least one of chassis cable aperture 102b, cup cable aperture 110c, yoke cable aperture 112c, magnet cable aperture 114e, plate aperture 116d and tweeter cable aperture 126d is different from at least one other aperture from the same group of cable apertures, such that the cable aperture with the smallest diameter is configured to allow passage of tweeter cable 154 there through.

Tweeter cable 154, according to some embodiments, includes at least two electric wires (not shown). Tweeter cable 154 passes through hollow passageway 190 until it protrudes upwards from tweeter cable aperture 126d (see FIGS. 9a-9b). At that point tweeter cable 154 can split to the at least two electric wires, each wire being held in place by a tweeter wire fastener 126f, the wire then passes through a tweeter wire opening 126e, to be finally attached at its tip to tweeter voice coil wire 124b.

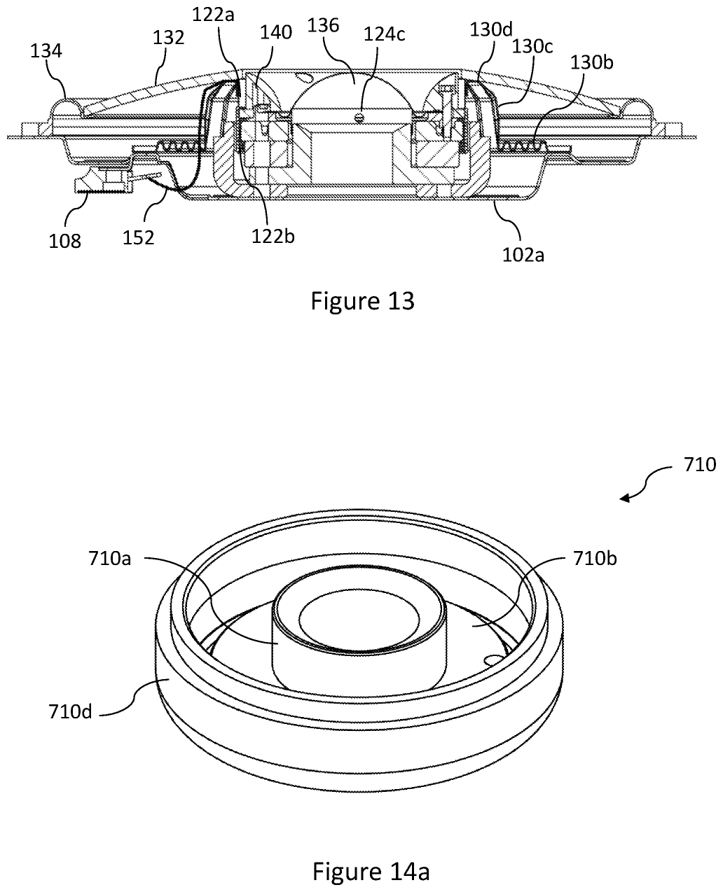

Reference is now made to FIG. 13. FIG. 13 constitutes a cross-sectional view of speaker driver 100 with spider 130 and a woofer cable 152, according to some embodiments. Woofer cable 152, according to some embodiments, includes at least two electric wires (not shown). Woofer cable 152 originates from woofer terminal 108, passing through a woofer cable opening in chassis 102 (not shown), following the contours of at least a portion of spider rising portion 130b and at least a portion of spider neck portion 130c, towards woofer voice coil 122, where each of the electric wires of woofer cable 152 connects with woofer voice coil wire 122b.

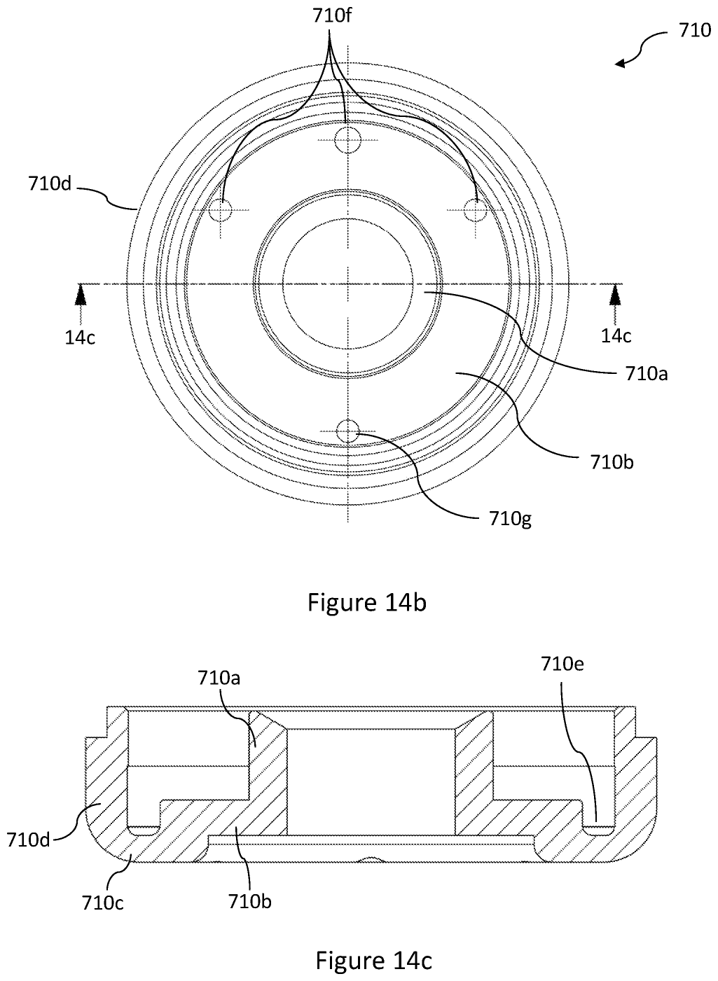

Reference is now made to FIGS. 14a-14c. FIGS. 14a and 14b constitute a view in perspective and a top-view, respectively, of a cup yoke 710, according to some embodiments. FIG. 14c constitutes a cross-sectional view of cup yoke 710 taken on line 14c-14c of FIG. 14b. Cup yoke 710 is an embodiment of a single component which replaces both cup 110 and T-yoke 112. Cup yoke 710 comprises a center pole 710a, a first yoke base portion 710b, a second yoke base portion 710c and a yoke sidewall 710d. According to some embodiments, the upper surface (not numbered) of first yoke base portion is vertically lower than the upper surface (not numbered) of the second yoke base portion, thereby forming yoke depression 710e, configured to allow movement of woofer voice coil 122 in the vertical direction.

According to some embodiments, yoke second base portion 710c includes at least one yoke cup thread aperture 710f, configured for vertical alignment with the at least one chassis attachment opening 102c, together forming at least one insertion through-hole for at least one fastening unit (not shown). The at least one fastening unit can be a screw, a bolt, a rivet and the like.

While an embodiment of cup yoke 710 is illustrated in FIG. 14b with three yoke cup thread apertures 710f, it will be understood by those of skill in the art that the number yoke cup thread apertures 710f vary to any other amount, at any location along either first yoke base portion 710b or second yoke base portion 710c.

According to some embodiments, cup yoke 710 includes a cup yoke cable aperture 710g, configured to replace both cup cable aperture 110c and yoke cable aperture 112c to form hollow passageway 190 in the same manner described hereinabove.

According to some embodiments, cup yoke 710 includes a geometrical separating feature (not shown), similar to geometrical separating feature 312c shown in FIG. 5c, located either in first yoke base portion 710b, second yoke base portion 710c, or both.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1. A speaker driver comprising:
a magnet having a magnet top portion, a magnet bottom portion, a magnet outer circumference and a magnet inner circumference;
a woofer voice coil disposed around the magnet outer circumference;
a tweeter voice coil disposed around the magnet inner circumference; and
a top plate adjacent on a horizontal plane to the magnet;
the top plate having a first plate portion and a second plate portion, separated by a geometrical separating feature,
wherein the magnet is configured to generate a first magnetic flux passing through the first plate portion and the woofer voice coil and a second magnetic flux passing through the second plate portion and the tweeter voice coil; and
wherein the location of the geometrical separating feature along the top plate is configured to influence the intensity of each of the first magnetic flux and the second magnetic flux.

2. The speaker driver of claim 1, wherein the woofer voice coil comprises a woofer former and a woofer voice coil wire wound around the woofer former; wherein the tweeter voice coil comprises a tweeter former and a tweeter voice coil wire wound around the tweeter former; and wherein the middle point along the vertical length of the woofer voice coil wire and the middle point along the vertical length of the tweeter voice coil wire are substantially in the same horizontal plane.

3. The speaker driver of claim 1, wherein the separating geometrical feature is a circumferential recess.

4. The speaker driver of claim 1, wherein the separating geometrical feature is located radially at the center of the top plate.

5. The speaker driver of claim 1, wherein the geometrical separating feature is located radially closer to the magnet inner circumference than to the magnet outer circumference.

6. The speaker driver of either one of claims 1 to 6, wherein the magnet comprises neodymium.

7. The speaker driver of claim 1, wherein the geometrical separating feature is protruding throughout the complete vertical height of the top plate, thereby spacing apart the first plate portion and the second plate portion.

8. The speaker driver of claim 1, further comprising:
a woofer diaphragm with a woofer surround, connected to a chassis having a chassis rim; and
a tweeter diaphragm with a tweeter surround, connected to a tweeter alignment component placed on top of the top plate,
wherein the woofer former is attached to the woofer diaphragm, and the tweeter former is attached to the tweeter diaphragm;
wherein the top plate comprises at least one plate recess; and
wherein the tweeter alignment component further comprises at least one alignment protrusion, configured to be accepted within the at least one plate recess, thereby aligning the tweeter alignment component and the top plate.

9. The speaker driver of claim 1, further comprising:
a chassis having a chassis base;
a cup having a cup base and a cup sidewall, wherein the cup base is disposed on the chassis base and the woofer voice coil is disposed within a first gap, formed between the cup sidewall and the magnet outer circumference; and
a yoke having a bottom yoke and a center pole, wherein the bottom yoke is disposed on the cup base and the tweeter voice coil is disposed within a second gap, formed between the center pole and the magnet inner circumference,
wherein the first magnetic flux runs from the magnet to the first plate portion, the first gap passing through the woofer voice coil, the cup sidewall, the cup base, the yoke bottom and back to the magnet; and
wherein the second magnetic flux runs from the magnet to the second plate portion, the second gap passing through the tweeter voice coil, the central pole, the bottom yoke and back to the magnet.

10. The speaker driver of claim 1, further comprising:
a chassis having a chassis base; and
a cup yoke having a center pole, a first yoke base portion having an upper surface, a second yoke base portion having an upper surface, and a cup yoke sidewall, wherein the upper surface of the first yoke base portion is vertically lower than the upper surface of the second yoke base portion, wherein the second yoke base portion is disposed on the chassis base, wherein the woofer voice coil is disposed within a first gap formed between the cup yoke sidewall and the magnet outer circumference, and wherein the tweeter voice coil is disposed within a second gap formed between the center pole and the magnet inner circumference,
wherein the first magnetic flux runs from the magnet to the first plate portion, the first gap passing through the woofer voice coil, the cup yoke sidewall, the second yoke base, the first yoke base and back to the magnet; and
wherein the second magnetic flux runs from the magnet to the second plate portion, the second gap passing through the tweeter voice coil, the central pole, the first yoke base and back to the magnet.

11. The speaker driver of claim 9, wherein the yoke base further comprises a yoke geometrical separating feature.

12. The speaker driver of claim 10, wherein the second yoke base portion further comprises a yoke geometrical separating feature.

13. The speaker driver of claim 8, further comprising a spider.

14. The speaker driver of claim 13, wherein the spider comprises
a spider corrugation portion having spider outer circumferential portion;
a spider rising portion;
a spider neck portion; and
at least one reinforcement rib, extending from at least a portion of the spider rising portion to at least a portion of the spider neck portion,
wherein the spider corrugation portion, the spider rising portion and the spider neck portion are formed as a single composite piece, and
wherein the spider is attached to the chassis via the spider outer circumferential portion, and to the woofer voice coil and the woofer diaphragm via the spider neck portion.

15. The speaker driver of claim 9, wherein the cup comprises a cup cable aperture, the yoke comprises a yoke cable aperture, the magnet comprises a magnet cable aperture, the top plate comprises a top plate cable aperture and the tweeter alignment component comprises a tweeter cable aperture; and wherein the cup cable aperture, the yoke cable aperture, the magnet cable aperture, the top plate cable aperture and the tweeter cable aperture are vertically aligned.

16. The speaker driver of claim 10, wherein the cup yoke comprises a cup yoke cable aperture, the magnet comprises a magnet cable aperture, the top plate comprises a top plate cable aperture and the tweeter alignment component comprises a tweeter cable aperture; and
wherein the cup cable aperture, the yoke cable aperture, the magnet cable aperture, the top plate cable aperture and the tweeter cable aperture are vertically aligned.
